(19) United States
(12) Patent Application Publication
(10) Pub. No.: US 2024/0018354 A1
(43) Pub. Date: Jan. 18, 2024

(54) Modified Polyphenylene Oxide Resin Composition

(71) Applicants: Hyundai Motor Company, Seoul (KR); Kia Corporation, Seoul (KR); SAMYANG CORPORATION, Seoul (KR)

(72) Inventors: Jae Hwan Ha, Hwaseong-si (KR); Si Yeol Yang, Daejeon (KR); Young Rock Kwon, Daejeon (KR); Nung Hyun Kim, Jinju-si (KR); Sang Hyun Park, Daejeon (KR)

(21) Appl. No.: 18/182,019

(22) Filed: Mar. 10, 2023

(30) Foreign Application Priority Data
Jul. 15, 2022 (KR) 10-2022-0087626

(51) Int. Cl. C08L 71/12; C08L 25/06; C08K 7/14; C08K 3/34; H01Q 1/22

(52) U.S. Cl. CPC C08L 71/123; C08L 25/06; C08K 7/14; C08K 3/346; H01Q 1/22; C08L 2205/03; C08K 2201/003; C08K 2201/004; C08K 2201/005

(57) ABSTRACT

In an embodiment, a polyphenylene oxide resin composition includes 24% by weight to 52% by weight of polyphenylene oxide (PPO), 13% by weight to 39% by weight of high Impact polystyrene (HIPS), 20% by weight to 25% by weight of inorganic filler, 5% by weight to 10% by weight of inorganic reinforcing material and 5% by weight to 10% by weight of impact modifier.

### CROSS-REFERENCE TO RELATED APPLICATIONS

The present application claims priority to Korean Patent Application No. 10-2022-0087626, filed on Jul. 5, 2022, the entire contents of which is incorporated herein for all purposes by this reference.

### TECHNICAL FIELD

The present disclosure relates to a modified polyphenylene oxide resin composition, and more particularly, to a modified polyphenylene oxide resin composition having low dielectric and high impact properties.

### BACKGROUND

Polyphenylene oxide (PPO) has excellent advantages over other engineering plastics in heat resistance, chemical resistance, and dimensional stability, so it is being applied as a housing material for semiconductors or automobile components. However, polyphenylene oxide (PPO) has a disadvantage in that it is difficult to mold alone due to low fluidity.

Therefore, the polyphenylene oxide is mainly mixed with polystyrene (PS), high impact polystyrene (HIPS), and polyamide (PA) to improve processability, and is also used by additionally adding fillers such as glass fibers or inorganic fillers in order to realize high rigidity.

Therefore, in general, a resin composition having improved physical properties such as rigidity or electrical conductivity by mixing polyphenylene oxide (PPO) with polystyrene, impact modifier, glass fiber, inorganic filler, carbon black, dispersant, etc. is widely used. However, such a general polyphenylene oxide (PPO)-based polymer material has a disadvantage in that it has low impact property in a ball drop, etc., and in particular, low dielectric properties that affect transmission and reception performances of communication components are not sufficient.

For this reason, there are many difficulties such as not satisfying the reliability required to directly employ a general polyphenylene oxide (PPO)-based polymer material as a housing material for a vehicle communication component such as a shark antenna.

The content described as the above background art is only for understanding the background of the present invention, and should not be taken as an acknowledgment that it corresponds to the prior art already known to those of ordinary skill in the art.

### SUMMARY

Embodiments provide a modified polyphenylene oxide resin composition having an improved composition of polyphenylene oxide (PPO)-based polymer material so that it has excellent rigidity and impact property, low shrinkage deviation and low dielectric properties so that it is suitable for use as a housing material for vehicle communication components.

The technical objects to be achieved by the present disclosure are not limited to the technical objects mentioned above, and other technical objects not mentioned can be clearly understood by those of ordinary skill in the art from the description of the present disclosure.

A modified polyphenylene oxide resin composition according to an embodiment of the present disclosure includes 24 to 52% by weight of polyphenylene oxide (PPO); 13 to 39% by weight of high impact polystyrene (HIPS); 20 to 25% by weight of inorganic filler; 5 to 10% by weight of inorganic reinforcing material; and 5 to 10% by weight of impact modifier.

Preferably, an alloy ratio of the polyphenylene oxide (PPO) and the high impact polystyrene (HIPS) is 4:6 to 8:2.

Preferably, the inorganic filler is glass fiber.

In this case, preferably, the glass fiber has an average diameter of 9 to 15 μm, and an average length of 3 to 4.5 mm.

In addition, the glass fiber is not oriented in a specific direction.

The inorganic reinforcing material is preferably kaolin.

In this case, preferably, the kaolin is in a form of a powder, and has an average particle size of 2 μm or less and a pH of 8 or more.

The impact modifier is preferably a styrene-ethylene/butylene-styrene (SEBS) block copolymer.

In this case, the content of styrene in the styrene-ethylene/butylene-styrene (SEBS) is preferably 30 to 35% by weight.

In addition, the composition according to an embodiment of the present disclosure has a permittivity of 3.1 F/m or less and a dielectric loss of 0.01 or less.

The composition has an impact strength of 6 KJ/m2 or more.

The composition has a flexural modulus of 5500 MPa or more.

The composition has a heat deflection temperature (HDT) of 125° C. or more.

The composition has a shrinkage deviation of 0.1% or less.

However, the shrinkage deviation is the difference between a horizontal shrinkage and a vertical shrinkage.

According to an embodiment of the present disclosure, by improving the composition of the modified polyphenylene oxide resin composition including polyphenylene oxide (PPO), high impact polystyrene (HIPS), inorganic filler, inorganic reinforcing material and impact modifier, a resin composition capable of implementing high impact and specific dielectric properties can be provided.

In particular, by using kaolin as the inorganic reinforcing material, the resin composition can have high impact strength property while reducing the amount of glass fiber, which is the inorganic filler, and can have specific dielectric properties (DK 3.1 or less, DF 0.01 or less). Accordingly, there are effects that the resin composition can be employed as a housing material for various communication components, and that it can be employed as a material for new communication components, which are in increasing demand according to the electrification and electricization of automobiles.

In addition, since the modified polyphenylene oxide resin composition according to an embodiment of the present disclosure has excellent dimensional stability, it can be employed as a housing material for components requiring precision such as 4D radar in the future.

### BRIEF DESCRIPTION OF THE DRAWINGS

FIG. 1a illustrates an SEM image of Example 1;

FIG. 1b illustrates an SEM image of Comparative Example 1-4;

FIG. 2a illustrates an image of a ball drop evaluation for Example 1;

FIG. 2b illustrates an image of a ball drop evaluation for Comparative Example 1-1; and

FIG. 2c illustrates an image of a ball drop evaluation for Comparative Example 2-1.

### DETAILED DESCRIPTION OF ILLUSTRATIVE EMBODIMENTS

Hereinafter, the embodiments disclosed in the present specification will be described in detail with reference to the accompanying drawings, but the same or similar components are given the same reference numerals regardless of reference numerals, and overlapping descriptions thereof will be omitted.

In describing the embodiments disclosed in the present specification, if it is determined that detailed descriptions of related known technologies may obscure the gist of the embodiments disclosed in this specification, the detailed description thereof will be omitted. In addition, the accompanying drawings are only for easy understanding of the embodiments disclosed in the present specification, and the technical spirit disclosed herein is not limited by the accompanying drawings, and it should be understood to include all modifications, equivalents and substitutes included in the spirit and scope of the present disclosure.

The singular expression includes the plural expression unless the context clearly dictates otherwise.

In this specification, terms such as “comprises” or “have” are intended to designate that the features, numbers, steps, operations, components, parts, or combinations thereof described in the specification exist, and it should be understood that this does not preclude the possibility of existence or addition of one or more other features, numbers, steps, operations, components, parts, or combinations thereof.

A modified polyphenylene oxide resin composition according to an embodiment of the present disclosure is a resin composition including polyphenylene oxide (hereinafter referred to as ‘PPO’), high impact polystyrene (hereinafter referred to as ‘HIPS’), inorganic filler, inorganic reinforcing material, and impact modifier, which has excellent rigidity and impact property, and has low shrinkage deviation and low dielectric properties. Such a resin composition may be employed as a housing material of a vehicle communication component.

Meanwhile, the modified polyphenylene oxide resin composition according to an embodiment of the present disclosure includes 24 to 52% by weight of polyphenylene oxide (PPO); 13 to 39% by weight of high impact polystyrene (HIPS); 20 to 25% by weight of inorganic filler; 5 to 10% by weight of inorganic reinforcing material; and 5 to 10% by weight of impact modifier.

The polyphenylene oxide (PPO) and the high impact polystyrene (HIPS) are the base resins constituting the modified polyphenylene oxide resin composition. The contents of polyphenylene oxide (PPO) and high impact polystyrene (HIPS) are preferably controlled in a range that improve other physical properties within a range that does not affect the permittivity and dielectric loss property.

Therefore, it is preferable to include 24 to 52% by weight of polyphenylene oxide

(PPO).

For example, the polyphenylene oxide (PPO) may be included in an amount of 24% by weight or more, 26% by weight or more, 28% by weight or more, 30% by weight or more, 32% by weight or more, 34% by weight or more, 36% by weight or more, or 39% by weight or more; and 52% by weight or less, 50% by weight or less, 48% by weight or less, 46% by weight or less, 44% by weight or less, 42% by weight or less, or 40% by weight or less.

If the content of polyphenylene oxide (PPO) is more than the suggested content range, there are problems of lowering impact strength and poor workability. Also, if the content of polyphenylene oxide (PPO) is less than the suggested content range, there is a problem in that the flexural modulus is lowered.

In addition, it is preferable to include 13 to 39% by weight of high-impact polystyrene (HIPS).

For example, the high impact polystyrene (HIPS) may be included in an amount of 13% by weight or more, 15% by weight or more, 17% by weight or more, 19% by weight or more, 20% by weight or more, 22% by weight or more, or 24% by weight or more; and 39% by weight or less, 37% by weight or less, 36% by weight or less, 34% by weight or less, 32% by weight or less, 30% by weight or less, 28% by weight or less, or 26% by weight or less.

If the content of high-impact polystyrene (HIPS) is greater than the suggested content range, there is a problem in that the heat deflection temperature (HDT) decreases. Further, if the content of high impact polystyrene (HIPS) is less than the suggested content range, there are problems in that the impact strength is lowered and the flexural modulus is lowered.

In particular, the alloy ratio of polyphenylene oxide (PPO) and high impact polystyrene (HIPS) is preferably 4:6 to 8:2.

If the content of polyphenylene oxide (PPO) is greater than the content suggested in the alloy ratio of polyphenylene oxide (PPO) and high impact polystyrene (HIPS), the impact strength and the flexural modulus are significantly lower than the required physical property level, and the processability deteriorates, resulting in a problem in that it is difficult to manufacture a uniform compound product.

In addition, if the content of high impact polystyrene (HIPS) is greater than the content suggested in the alloy ratio of polyphenylene oxide (PPO) and high impact polystyrene (HIPS), there are problems in that the impact strength is lowered and the ball drop evaluation cannot be passed.

The inorganic filler and the inorganic reinforcing material are materials added to reinforce the rigidity of the modified polyphenylene oxide resin composition, and in this embodiment, the glass fiber is used as the inorganic filler and kaolin is preferably used as the inorganic reinforcing material.

By using the glass fiber and the kaolin together in this way, it is possible to hybridize the glass fiber and the kaolin to improve dielectric properties and shrinkage deviation.

As the glass fiber and the kaolin are hybridized in this way, the effect of improving dimensional stability and dielectric properties can be expected as the glass fiber is not oriented in a specific direction and is arranged irregularly.

For this purpose, it is preferable to include 20 to 25% by weight of glass fiber.

If the content of glass fiber is greater than the suggested content range, although the impact strength and the flexural modulus are improved, a problem occurs in that the dielectric properties are deteriorated. In addition, if the content of glass fiber is less than the suggested content range, there are problems in that the flexural modulus deteriorates and the ball drop evaluation cannot be passed.

In particular, it is preferable to use the glass fiber having an average diameter of 9 to 15 μm and an average length of 3 to 4.5 mm.

If the average diameter of glass fiber satisfies the suggested range, handling and feeding characteristics are excellent, so that smooth input is possible in an extrusion process. In addition, if the average length of glass fiber is less than 3 mm, there is a problem in that the impact strength may be lowered, and if the average length of glass fiber exceeds 4.5 mm, there is a problem in that the appearance quality of the molded article may be deteriorated.

In addition, it is preferable to include 5 to 10% by weight of kaolin.

If the content of kaolin is greater than the suggested content, the dielectric properties are improved, but the impact strength and the flexural modulus are deteriorated. In addition, if the content of kaolin is less than the suggested content, there are problems in that the dielectric properties are deteriorated, and the failure of ball drop evaluation occurs.

In particular, if kaolin is not included, there are problems in that paintability cannot be secured and flexural modulus is deteriorated.

In this case, it is preferable that kaolin is included in the form of powder, the average particle size of kaolin is 2 μm or less, and the pH is 8 or more.

If the kaolin is not in the form of powder or the average particle size exceeds 2 μm, the dispersibility in the resin is lowered, resulting in a problem that impact strength is significantly lower than the required physical property level. In addition, if the pH of kaolin is less than 8, compatibility between kaolin and resin is lowered, which may cause a problem in that impact strength is lowered.

The impact modifier is a material added to reinforce the impact property of the modified polyphenylene oxide resin composition. In this embodiment, a styrene-ethylene/butylene-styrene (SEBS) block copolymer is preferably used as the impact modifier.

In this case, the impact modifier is preferably included in an amount of 5 to 10% by weight.

If the content of impact modifier is greater than the suggested content range, the flexural modulus deteriorates, and if the content of impact modifier is less than the suggested content range, there is a problem in that ball drop evaluation cannot be passed.

Meanwhile, the content of styrene in styrene-ethylene/butylene-styrene (SEBS) is preferably 30 to 35% by weight.

If the content of styrene in styrene-ethylene/butylene-styrene (SEBS) is less than 30% by weight, there may be a problem that flexural modulus is significantly lower than the required physical property level, and if it exceeds 35% by weight, a problem of lowering the impact strength may occur.

In addition, the modified polyphenylene oxide resin composition according to an embodiment of the present disclosure may have the permittivity of 3.1 F/m or less, preferably 3.07 F/m or less, and more preferably 3.05 F/m or less.

In addition, the modified polyphenylene oxide resin composition according to an embodiment of the present disclosure may have the dielectric loss of 0.01 or less, preferably 0.009 or less, 0.008 or less, 0.007 or less, or 0.006 or less.

In addition, the modified polyphenylene oxide resin composition according to an embodiment of the present disclosure may have the impact strength of 6 KJ/m2 or more, preferably 6.2 KJ/m2 or more, 6.4 KJ/m2 or more, or 6.6 KJ/m2 or more.

In addition, the modified polyphenylene oxide resin composition according to an embodiment of the present disclosure may have the flexural modulus of 5500 MPa or more, preferably 5510 MPa or more, 5520 MPa or more, or 553o MPa or more.

In addition, the modified polyphenylene oxide resin composition according to an embodiment of the present disclosure may have the heat deflection temperature (HDT) of 125° C. or more.

In addition, the modified polyphenylene oxide resin composition according to an embodiment of the present disclosure may have the shrinkage deviation (difference between horizontal and vertical shrinkages) of 0.1% or less, preferably 0.09% or less, 0.08% or less, or 0.07% or less.

In addition, the modified polyphenylene oxide resin composition according to an embodiment of the present disclosure is characterized in that when the paintability evaluation and the ball drop evaluation are performed by the following evaluation method, both evaluations are passed (OK).

Meanwhile, the present disclosure can provide a molded article manufactured by

processing the modified polyphenylene oxide resin composition described above.

In this case, the molded article may be used without limitation as long as it is a component to which low dielectric properties are applied, and may be, for example, a housing for a communication component.

Hereinafter, the present disclosure will be described with reference to Examples and Comparative Examples of the present disclosure.

As shown in Tables 1 to 4 below, each ingredient was uniformly mixed by a super mixer while changing the content of each ingredient, and then melt-kneaded at 220 to 300° C. by a twin-screw extruder to make a pellet through extrusion processing. Then, after drying the prepared pellet according to each of Examples and Comparative Examples at 100° C. for 5 hours or more, it was molded using an LS 170 ton injection machine at the injection temperature section of 220 to 300° C. and at the mold section of 60 to 100° C. Various physical properties of each prepared composition were measured and shown together in Tables 5 to 8.

While the contents of PPO and HIPS are shown in Tables 1 to 3, the value in parentheses indicates the alloy ratio of PPO and HIPS.

Here, each ingredient used is as follows.
1) Polyphenylene oxide: PX-100F (Mitsubishi)
2) High Impact Polystyrene: HI425TVL (Kumho)
3) E-Glass Fiber: 910-10P (OWENSCORNING)
4) Kaolin: Translink445 (BASF)
5) SEBS-based impact modifier: Taipol6151 (TSRC)
6) Polyamid 6: EN300 (KP Chemtech)
7) Polybutylene Terephthalate: 211M (Changchun)
8) Polyamid 6,6: U4800 (INVISTA)

Then, the physical properties of the obtained resin compositions according to Examples and Comparative Examples were measured in the following manner.

1) Dielectric properties: The permittivity and dielectric loss were measured, and the average value was used by measuring a disk of 2 mm three times using a reflectance method (60 GHz).

2) Impact strength (KJ/m2): It was measured in accordance with ISO 179, and it was measured after 20% notched on a specimen with a width of 80 mm, a length of 10 mm, and a thickness of 4 mm

3) Flexural modulus (MPa): It was measured in accordance with ISO 178, and a specimen with a width of 80 mm, a length of 10 mm, and a thickness of 4 mm was measured at a test speed of 2 mm/min.

4) Heat distortion temperature (HDT)(° C.): It was measured in accordance with ISO 75, and measurement was proceeded while heating a specimen with a width of 80 mm, a length of 10 mm, and a thickness of 4 mm at a rate of 120° C./h.

5) Ball drop evaluation: It was measured by dropping a ball weighing 220 g from a height of 60 cm on a disk specimen with a diameter of 100 mm and a thickness of 2 mm based on a ball weight of 220 g and a height of 60 cm.

6) Shrinkage (%) deviation: It was measured according to ASTM D955, the distance between the gage points on the outer portion of a disk specimen having a diameter of 100 mm and a thickness of 3 mm was measured using a dimension measuring machine, and the shrinkage in the vertical and horizontal directions after injection was measured. Then, the shrinkage deviation (horizontal shrinkage/vertical shrinkage) was calculated.

TABLE 1

| Category | Example | | | | | | |
|---|---|---|---|---|---|---|---|
| (wt %) | 1 | 2 | 3 | 4 | 5 | 6 | 7 |
| PPO | 39 (6) | 39 (6) | 36 (6) | 52 (8) | 52 (8) | 39 (6) | 24 (4) |
| HIPS | 26 (4) | 26 (4) | 24 (4) | 13 (2) | 13 (2) | 26 (4) | 36 (6) |
| GF | 20 | 25 | 25 | 20 | 25 | 25 | 25 |
| Kaolin | 10 | 5 | 5 | 10 | 5 | 5 | 5 |
| SEBS-based | 5 | 5 | 10 | 5 | 5 | 5 | 10 |
| impact modifier | | | | | | | |

TABLE 2

| Category | Comparative Example 1 | | | | | | | |
|---|---|---|---|---|---|---|---|---|
| (wt %) | 1 | 2 | 3 | 4 | 5 | 6 | 7 | 8 |
| PPO | 54 (6) | 48 (6) | 42 (6) | 39 (6) | 36 (6) | 90 (9) | 26 (4) | 26 (4) |
| HIPS | 36 (4) | 32 (4) | 28 (4) | 26 (4) | 24 (4) | 10 (1) | 39 (6) | 39 (6) |
| GF | 10 | 20 | 30 | 30 | 30 | 0 | 30 | 15 |
| Kaolin | 0 | 0 | 0 | 0 | 0 | 0 | 0 | 15 |
| SEBS-based | 0 | 0 | 0 | 5 | 10 | 0 | 5 | 5 |
| impact modifier | | | | | | | | |

TABLE 3

| Category | Comparative Example 1 | | | | | | |
|---|---|---|---|---|---|---|---|
| (wt %) | 9 | 10 | 11 | 12 | 13 | 14 | 15 |
| PPO | 22 (4) | 48 (8) | 44 (8) | 28 (4) | 26 (4) | 24 (4) | 35 (6) |
| HIPS | 33 (6) | 12 (2) | 11 (2) | 42 (6) | 39 (6) | 36 (6) | 24 (4) |
| GF | 25 | 15 | 20 | 25 | 26 | 19 | 20 |
| Kaolin | 5 | 15 | 10 | 5 | 4 | 11 | 10 |
| SEBS-based | 15 | 10 | 15 | 0 | 5 | 10 | 11 |
| impact modifier | | | | | | | |

TABLE 4

| Category | Comparative Example 2 | | | | | | | | |
|---|---|---|---|---|---|---|---|---|---|
| (wt %) | 1 | 2 | 3 | 4 | 5 | 6 | 7 | 8 | 9 |
| PPO | 0 | 0 | 0 | 0 | 0 | 60 | 54 | 48 | 42 |
| HIPS | 0 | 0 | 0 | 0 | 0 | 0 | 0 | 0 | 0 |
| PA6 | 0 | 0 | 0 | 0 | 70 | 0 | 0 | 0 | 0 |
| PBT | 100 | 90 | 80 | 70 | 0 | 0 | 0 | 0 | 0 |
| PA66 | 0 | 0 | 0 | 0 | 0 | 40 | 36 | 32 | 28 |
| GF | 0 | 10 | 20 | 30 | 30 | 0 | 10 | 20 | 30 |
| Kaolin | 0 | 0 | 0 | 0 | 0 | 0 | 0 | 0 | 0 |
| SEBS-based | 0 | 0 | 0 | 0 | 0 | 0 | 0 | 0 | 0 |
| impact modifier | | | | | | | | | |

TABLE 5

| Category | Example | | | | | | |
|---|---|---|---|---|---|---|---|
| (wt %) | 1 | 2 | 3 | 4 | 5 | 6 | 7 |
| Permittivity | 3.01 | 3.04 | 3.03 | 3.00 | 3.02 | 3.05 | 3.03 |
| (F/m) | | | | | | | |
| Dielectric | 0.0051 | 0.0062 | 0.0061 | 0.0047 | 0.0065 | 0.0065 | 0.0059 |
| loss | | | | | | | |
| Impact | 6.7 | 7.9 | 10.7 | 6.7 | 8.0 | 8.1 | 10.7 |
| strength | | | | | | | |
| (KJ/m²) | | | | | | | |
| Flexural | 5530 | 5730 | 5540 | 5800 | 6300 | 5580 | 5600 |
| modulus | | | | | | | |
| (Mpa) | | | | | | | |
| HDT | 147.4 | 145.4 | 138.0 | 166.4 | 167.6 | 128.0 | 125.0 |
| (° C.) | | | | | | | |
| Paintability | OK | OK | OK | OK | OK | OK | OK |
| evaluation | | | | | | | |
| Ball drop | OK | OK | OK | OK | OK | OK | OK |
| evaluation | | | | | | | |
| Horizontal | 0.40 | 0.43 | 0.44 | 0.39 | 0.41 | 0.43 | 0.45 |
| shrinkage | | | | | | | |
| (%) | | | | | | | |
| Vertical | 0.35 | 0.36 | 0.37 | 0.34 | 0.35 | 0.37 | 0.38 |
| shrinkage | | | | | | | |
| (%) | | | | | | | |
| Shrinkage | 0.05 | 0.07 | 0.07 | 0.05 | 0.06 | 0.06 | 0.07 |
| deviation | | | | | | | |
| (%) | | | | | | | |

TABLE 6

| Category | Comparative Example 1 | | | | | | | |
|---|---|---|---|---|---|---|---|---|
| (wt %) | 1 | 2 | 3 | 4 | 5 | 6 | 7 | 8 |
| Permittivity | 2.70 | 2.91 | 3.11 | 3.11 | 3.11 | 2.59 | 3.11 | 3.01 |
| (F/m) | | | | | | | | |
| Dielectric | 0.0074 | 0.0890 | 0.0115 | 0.0113 | 0.0110 | 0.0021 | 0.0112 | 0.0048 |
| loss | | | | | | | | |
| Impact | 6.2 | 9.5 | 12.0 | 16.3 | 17.6 | 2.4 | 13.9 | 4.1 |
| strength | | | | | | | | |
| (KJ/m²) | | | | | | | | |
| Flexural | 3550 | 4825 | 7000 | 6100 | 5450 | 2505 | 5640 | 5480 |
| modulus | | | | | | | | |
| (Mpa) | | | | | | | | |
| HDT | 142.0 | 145.0 | 145.0 | 146.0 | 141.0 | 166.0 | 126.0 | 130.0 |
| (° C.) | | | | | | | | |
| Paintability | NG | NG | NG | NG | NG | OK | NG | OK |
| evaluation | | | | | | | | |
| Ball drop | NG | NG | NG | OK | OK | OK | OK | NG |
| evaluation | | | | | | | | |
| Horizontal | 0.65 | 0.60 | 0.54 | 0.54 | 0.59 | 0.45 | 0.58 | 0.38 |
| shrinkage | | | | | | | | |
| (%) | | | | | | | | |
| Vertical | 0.45 | 0.42 | 0.35 | 0.35 | 0.37 | 0.35 | 0.36 | 0.34 |
| shrinkage | | | | | | | | |
| (%) | | | | | | | | |
| Shrinkage | 0.20 | 0.18 | 0.19 | 0.19 | 0.22 | 0.10 | 0.22 | 0.04 |
| deviation | | | | | | | | |
| (%) | | | | | | | | |

TABLE 7

| Category | Comparative Example 1 | | | | | | |
|---|---|---|---|---|---|---|---|
| (wt %) | 9 | 10 | 11 | 12 | 13 | 14 | 15 |
| Permittivity | 3.04 | 2.99 | 3.02 | 3.04 | 3.11 | 3.01 | 3.03 |
| (F/m) | | | | | | | |
| Dielectric | 0.0060 | 0.0047 | 0.0053 | 0.0060 | 0.0106 | 0.0053 | 0.0054 |
| loss | | | | | | | |
| Impact | 12.1 | 4.9 | 9.8 | 4.3 | 5.4 | 5.6 | 5.7 |
| strength | | | | | | | |
| (KJ/m²) | | | | | | | |
| Flexural | 5020 | 5420 | 5050 | 5680 | 5370 | 5120 | 5080 |
| modulus | | | | | | | |
| (Mpa) | | | | | | | |
| HDT | 112.0 | 148.0 | 121.0 | 127.0 | 123.0 | 116.0 | 119.0 |
| (° C.) | | | | | | | |
| Paintability | OK | OK | OK | OK | OK | OK | OK |
| evaluation | | | | | | | |
| Ball drop | OK | NG | OK | NG | NG | NG | NG |
| evaluation | | | | | | | |
| Horizontal | 0.47 | 0.40 | 0.44 | 0.40 | 0.42 | 0.42 | 0.43 |
| shrinkage | | | | | | | |
| (%) | | | | | | | |
| Vertical | 0.39 | 0.35 | 0.38 | 0.35 | 0.36 | 0.37 | 0.36 |
| shrinkage | | | | | | | |
| (%) | | | | | | | |
| Shrinkage | 0.08 | 0.05 | 0.06 | 0.05 | 0.06 | 0.05 | 0.07 |
| deviation | | | | | | | |
| (%) | | | | | | | |

TABLE 8

| Category | Comparative Example 2 | | | | | | | | |
|---|---|---|---|---|---|---|---|---|---|
| (wt %) | 1 | 2 | 3 | 4 | 5 | 6 | 7 | 8 | 9 |
| Permittivity | 2.93 | 3.17 | 3.34 | 3.44 | 3.35 | 2.65 | 2.81 | 2.96 | 3.21 |
| (F/m) | | | | | | | | | |
| Dielectric | 0.0117 | 0.0123 | 0.0139 | 0.0145 | 0.0151 | 0.0115 | 0.0138 | 0.0116 | 0.0159 |
| loss | | | | | | | | | |
| Impact | 4.2 | 6.5 | 7.2 | 9.3 | 5.8 | 2.0 | 2.0 | 5.1 | 6.2 |
| strength | | | | | | | | | |
| (KJ/m²) | | | | | | | | | |
| Flexural | 2380 | 3500 | 4500 | 7350 | 6120 | 2630 | 3950 | 5835 | 7520 |
| modulus | | | | | | | | | |
| (Mpa) | | | | | | | | | |
| HDT | 55.0 | 165.0 | 203.0 | 205.0 | 201.0 | 170.0 | 196.0 | 202.0 | 202.0 |
| (° C.) | | | | | | | | | |
| Ball drop | NG | NG | NG | NG | OK | NG | NG | NG | NG |
| evaluation | | | | | | | | | |
| Horizontal | 2.30 | 1.20 | 1.00 | 0.82 | 0.77 | 0.73 | 0.65 | 0.63 | 0.57 |
| shrinkage | | | | | | | | | |
| (%) | | | | | | | | | |
| Vertical | 1.40 | 0.30 | 0.30 | 0.41 | 0.35 | 0.50 | 0.45 | 0.42 | 0.35 |
| shrinkage | | | | | | | | | |
| (%) | | | | | | | | | |
| Shrinkage | 0.90 | 0.90 | 0.70 | 0.41 | 0.42 | 0.23 | 0.21 | 0.21 | 0.22 |
| deviation | | | | | | | | | |
| (%) | | | | | | | | | |

As can be seen from the above tables, in Examples 1 to 7 in which the contents of PPO and HIPS were within the range presented in this embodiment, and the alloy ratio was maintained between 4:6 and 8:2, it was confirmed that the permittivity was 3.1 F/m or less, and the dielectric loss was 0.01 or less. In addition, it was confirmed that the impact strength was 6 KJ/m2 or more, the flexural modulus was 5500 MPa or more, the heat deflection temperature (HDT) was 125° C. or more, and the shrinkage deviation was 0.1% or less.

However, even if the alloy ratio of PPO and HIPS was maintained between 4:6 and 8:2, it was confirmed that Comparative Example 1-12 in which the content of HIPS exceeded the range presented in this embodiment did not satisfy the ball drop evaluation.

In addition, in Comparative Example 1-6 in which the content of PPO exceeded the range presented in this embodiment and the alloy ratio of PPO and HIPS also exceeded the range presented in this embodiment, it was confirmed that the impact strength and the flexural modulus did not satisfy the physical property values of 6 KJ/m2 or more and 5500 MPa or more.

In addition, in Comparative Examples 1-3, 1-4, 1-5, and 1-7 in which the content of glass fiber, which was the inorganic filler, exceeded the range presented in this embodiment, it was confirmed that the impact strength and flexural modulus properties satisfied the required physical property values, but that the permittivity and the dielectric loss did not satisfy the required physical property values of 3.1 F/m or less and 0.01 or less.

In addition, in Comparative Example 1-1 in which the content of glass fiber, which was the inorganic filler, was less than the range presented in this embodiment, it was confirmed that the required flexural modulus of 5500 or more was not satisfied.

In addition, in Comparative Examples 1-8 and 1-10 in which the content of inorganic reinforcing material, kaolin, exceeded the range presented in this embodiment, it was confirmed that the permittivity and dielectric loss properties satisfied the required physical property values, but that the impact strength and the flexural modulus did not satisfy the required physical property values of 6 KJ/m2 or more and 5500 MPa or more.

In addition, in Comparative Example 1-13 in which the content of inorganic reinforcing material, kaolin, was less than the range presented in this embodiment, it was confirmed that the permittivity and the dielectric loss did not satisfy the required values of 3.1 F/m or less and 0.01 or less.

In particular, it was confirmed that in Comparative Example 1-2 which did not include the inorganic reinforcing material, kaolin, it was confirmed that paintability could not be secured, and the flexural modulus did not satisfy the required value of 5500 or more.

In addition, in Comparative Examples 1-9 and 1-11 in which the content of SEBS-based impact modifier, which was the impact modifier, exceeded the range presented in this embodiment, it was confirmed that the flexural modulus did not satisfy the required value of 5500 or more.

In addition, it was confirmed that the ball drop evaluation was not satisfied in Comparative Examples 1-2 and 1-12 in which the SEBS-based impact modifier, which was an impact modifier, was not included.

On the other hand, through Comparative Examples 2-1 to 2-5, when PA6, PBT and PA 66, which were pseudo plastics replacing PPE and HIPS, were used as base resins, it was confirmed that the properties required by the present disclosure, the dielectric constant of 3.1 F/m or less, the dielectric loss of 0.01 or less, the impact strength of 6 KJ/m2 or more, the flexural modulus of 5500 MPa or more, the thermal deformation temperature (HDT) of 125° C. or more, and the shrinkage deviation of 0.1% or less were not satisfied at the same time.

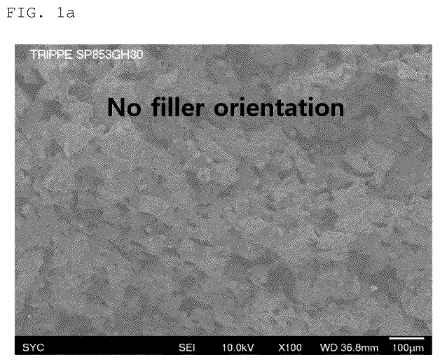

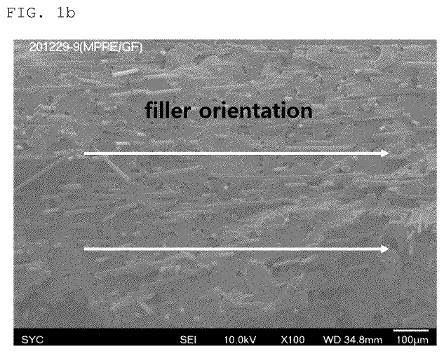

Meanwhile, in order to find out the orientation characteristics of glass fiber in the case of using the inorganic reinforcing material together with the inorganic filler, the SEM analysis was performed on Example 1 in which glass fiber and kaolin were hybridized by using the inorganic reinforcing material together with the inorganic filler, and Comparative Example 1-4 in which only glass fiber was included as the inorganic filler and kaolin, the inorganic reinforcing material, was not included. The results were shown in FIGS. 1a and 1b.

FIG. 1a illustrates an SEM image of Example 1, and FIG. 1b illustrates an SEM image

of Comparative Example 1-4.

As can be seen in FIG. 1a, when the content of glass fiber added for reinforcement was reduced and kaolin was also included as in Example 1, it was confirmed that the orientation of glass fiber in a specific direction was not shown, so that it was confirmed that dimensional stability and dielectric properties were improved.

On the other hand, as can be seen in FIG. 1b, it was confirmed that the glass fiber was oriented in a certain direction when only glass fiber was contained as the filler without kaolin as in Comparative Example 1-4. The glass fiber has a high aspect ratio, so that there is a tendency to be deflected depending on the injection direction. In the case of FIG. 1b, the injection direction was the x-axis direction, and it was confirmed that the glass fiber was oriented along the x-axis direction. Accordingly, it was confirmed that Comparative Example 1-4 had poor dimensional stability and dielectric properties compared to the Examples.

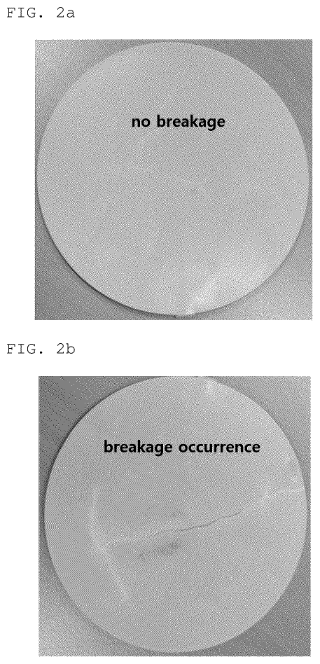

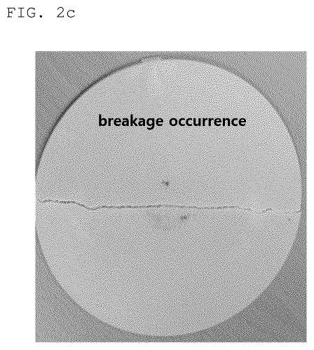

On the other hand, the ball drop evaluation was performed to find out the characteristics between the type and content of the base resin and the contents of the inorganic filler and inorganic reinforcing material, and the images of the ball drop evaluation for Example 1, Comparative Example 1-1 and Comparative Example 2-1 were shown in FIGS. 2a to 2c.

FIG. 2a illustrates an image of ball drop evaluation for Example 1, FIG. 2b illustrates an image of ball drop evaluation for Comparative Example 1-1, and FIG. 2c illustrates an image of ball drop evaluation for Comparative Example 2-1.

As can be seen in FIG. 2a, as in Example 1 in which PPE and HIPS as the base resin satisfied the content range and alloy ratio defined in the present disclosure, and the inorganic filler and the inorganic reinforcing material were included together, it was confirmed that any breakage did not occur in the ball drop evaluation. Therefore, it was confirmed that the resin composition according to the embodiment of the present disclosure can be used as a housing material for components mounted in an exposed space, such as a roof that is in direct contact with hail, snow, rain, and the like.

On the other hand, in the case of Comparative Examples 1-1 and 2-1 that did not satisfy the composition and content limited by the present disclosure, it was confirmed that breakage occurred in the ball drop evaluation, as shown in FIGS. 2b and 2c.

Although the present disclosure has been described with reference to the accompanying drawings and the above-described preferred embodiments, the present disclosure is not limited thereto, but is defined by the following claims. Accordingly, those of ordinary skill in the art can variously change and modify the present disclosure within the scope without departing from the spirit of the claims to be described later.

What is claimed is:

1. A polyphenylene oxide resin composition comprising:
24% by weight to 52% by weight of polyphenylene oxide (PPO);
13% by weight to 39% by weight of high impact polystyrene (HIPS);
20% by weight to 25% by weight of inorganic filler;
5% by weight to 10% by weight of inorganic reinforcing material; and
5% by weight to 10% by weight of impact modifier.

2. The polyphenylene oxide resin composition according to claim 1, wherein the polyphenylene oxide (PPO) has 28% by weight to 48% by weight.

3. The polyphenylene oxide resin composition according to claim 1, wherein the polyphenylene oxide (PPO) has 34% by weight to 42% by weight.

4. The polyphenylene oxide resin composition according to claim 1, wherein of high impact polystyrene (HIPS) has 17% by weight to 36% bt weight. The polyphenylene oxide resin composition according to claim 1, wherein of high impact polystyrene (HIPS) has 22% by weight to 30% bt weight.

6. The polyphenylene oxide resin composition according to claim 1, wherein an alloy ratio of the polyphenylene oxide (PPO) and the high impact polystyrene (HIPS) is 4:6 to 8:2.

7. The polyphenylene oxide resin composition according to claim 1, wherein the inorganic filler is glass fiber.

8. The polyphenylene oxide resin composition according to claim 7, wherein the glass fiber has an average diameter of 9 μm to 15 μm, and an average length of 3 mm to 4.5 mm.

9. The polyphenylene oxide resin composition according to claim 7, wherein the glass fiber is not oriented in a specific direction.

10. The polyphenylene oxide resin composition according to claim 1, wherein the inorganic reinforcing material is kaolin.

11. The polyphenylene oxide resin composition according to claim 10, wherein the kaolin is in a form of a powder and has an average particle size of 2 μm or less and a pH of 8 or more.

12. The polyphenylene oxide resin composition according to claim 1, wherein the impact modifier is a styrene-ethylene/butylene-styrene (SEBS) block copolymer.

13. The polyphenylene oxide resin composition according to claim 12, wherein a content of a styrene in the styrene-ethylene/butylene-styrene (SEBS) is 30% by weight to 35% by weight.

14. The polyphenylene oxide resin composition according to claim 1, wherein the polyphenylene oxide resin composition has a permittivity of 3.1 F/m or less and a dielectric loss of 0.01 or less.

15. The polyphenylene oxide resin composition according to claim 1, wherein the polyphenylene oxide resin composition has an impact strength of 6 KJ/m² or more.

16. The polyphenylene oxide resin composition according to claim 1, wherein the polyphenylene oxide resin composition has a dielectric loss of 0.01 or less.

17. The polyphenylene oxide resin composition according to claim 1, wherein the polyphenylene oxide resin composition has a flexural modulus of 5500 MP or more.

18. The polyphenylene oxide resin composition according to claim 1, wherein the polyphenylene oxide resin composition has a deat deflection temperature (HDT) of 125° C. or more.

19. A molded article manufactured by processing the polyphenylene oxide resin composition of claim 1.

20. The molded article according to claim 19, wherein the molded article is a housing for a communication component.
